(19) United States
(12) Patent Application Publication
(10) Pub. No.: US 2010/0171858 A1
(43) Pub. Date: Jul. 8, 2010

(54) DISPLAY CONTROL DEVICE AND CONTROL METHOD THEREOF

(75) Inventor: Toshifumi Osawa, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/642,236

(22) Filed: Dec. 18, 2009

(30) Foreign Application Priority Data
Jan. 7, 2009 (JP) 2009-001855

(51) Int. Cl. G09G 5/10; G06F 3/038; H04N 5/222

(52) U.S. Cl. 348/333.01; 345/690; 345/207; 348/E05.022

(57) ABSTRACT

A display control device capable of suppressing an abrupt change in brightness of a display device viewed by a user when a large change takes place in outside light illuminance, thereby relieving a viewing difficulty. A control unit detects illuminance of outside light irradiated onto the display device, calculates a target brightness value corresponding to the detected illuminance, and sets a brightness setting value for the display device based on the target brightness value. If there is continuity in display content of the display device, the brightness setting value is set while providing an upper limit value for an amount of change in target brightness value. If the display content is changed without continuity, the target brightness value is set as the brightness setting value while unrestricting the amount of change in the target brightness value.

### BACKGROUND OF THE INVENTION

1. Field of the Invention

The present invention relates to a display control device for controlling a display device that displays an image, and a control method of the display control device.

2. Description of the Related Art

Conventionally, most digital cameras for recording and displaying an electronic image photoelectrically converted by an image pickup device have a display device that displays a recorded image and information required for photographing.

As the display device, a TFT liquid crystal display device is generally used, but sometimes an organic EL display device or the like is used.

There are three types of TFT liquid crystal display devices, i.e., a transmissive type, a reflective type, and a semi-transmissive type. For the purpose to display an image recorded by a digital camera, the transmissive type display device is mostly used, which is excellent in image display performance (e.g., contrast and color reproduction) but requires a back light. Thus, the transmissive type display device is comprised of a liquid crystal panel and a back light, which is, e.g., a combination of white LEDs and light guide plates.

In such a display device, the display brightness is determined by the transmittance of the liquid crystal panel and the brightness of the back light.

Since the digital camera is used in various environments such as outside in clear weather and in a dark room, the display brightness of the display device is automatically and optimally adjusted according to the brightness of environmental light (see, Japanese Laid-open Patent Publications Nos. H8-242398 and 2007-258785).

An electronic camera disclosed in Japanese Laid-open Patent Publication No. H8-242398 acquires information on the brightness of environmental light (i.e., the illuminance of outside light irradiated onto the camera) from video information obtained by an image pickup device, and adjusts the brightness of a back light. Japanese Laid-open Patent Publication No. H8-242398 also discloses decreasing the brightness of the back light during the time a camera strobe is being charged in order to ensure the charging electric power.

Japanese Laid-open Patent Publication No. 2007-258785 discloses a camera in which information on the brightness of environmental light for adjustment of the brightness of the back light is acquired not only from video information obtained by an image pickup device, but also from information on the illuminance of outside light irradiated onto the camera, which is obtained by a light metering device provided on a rear surface of the camera.

However, the conventional display control device entails the following problem. Specifically, the cameras disclosed in Japanese Laid-open Patent Publications Nos. H8-242398 and 2007-258785 are able to change the brightness of the display device to an easily viewable level according to a change in outside light illuminance, but repetitive abrupt increase and decrease in the brightness of the liquid display device are sometimes caused by a large change in illuminance of outside light irradiated onto the camera, the large change being caused, e.g., when sunlight is cut off by the camera user when the camera is used outside. In that case, if the brightness is simply adjusted according to a change in outside light illuminance, there occurs an abrupt change in brightness of the display device, and as a result, the camera user feels a difficulty in viewing the display.

It appears possible to moderate the change in brightness of the display device by restricting an amount of change in brightness of the display device when the outside light illuminance largely changes. In that case, however, a drawback is posed, for example, that it takes much time to reach the brightness of the display device to an optimum level when the outside light illuminance changes.

### SUMMARY OF THE INVENTION

The present invention provides a display control device and a control method thereof capable of suppressing an abrupt change in brightness of a display device viewed by a user, which is caused when a large change takes place in illuminance of outside light irradiated onto the display device, and thereby relieving a viewing difficulty, and also provides a display control device and a control method thereof capable of ensuring that the display brightness can follow up a change in outside light illuminance, without giving a user an unnatural feeling.

According to a first aspect of this invention, there is provided a display control device for controlling a display device that displays an image, comprising a detection unit configured to detect illuminance of outside light irradiated onto the display device, an acquisition unit configured to acquire a target brightness value corresponding to the detected illuminance of outside light, and a control unit configured to control brightness of the display device to a brightness setting value set based on the acquired target brightness value, wherein the control unit sets the brightness setting value while restricting an amount of change in the target brightness value in a case where there is continuity in display content of the display device, and sets the target brightness value as the brightness setting value while unrestricting the amount of change in the target brightness value in a case where the display content of the display device is changed without continuity.

According to a second aspect of this invention, there is provided a display control device for controlling a display device that displays an image, comprising a detection unit configured to detect illuminance of outside light irradiated onto the display device, an acquisition unit configured to acquire a target brightness value corresponding to the detected illuminance of outside light, and a control unit configured to control brightness of the display device to a brightness setting value set based on the acquired target brightness value, wherein based on the illuminance of outside light detected by the detection unit, the acquisition unit acquires the target brightness value at a timing where the display content of the display device is changed without continuity.

According to third and fourth aspects of this invention, there are provided display control methods respectively corresponding to the display control devices according to the first and second aspects of this invention.

With this invention, the brightness setting value is set while restricting an amount of change in the target brightness value in a case where there is continuity in display content of the display device, whereas the target brightness value is set as the brightness setting value while unrestricting the amount of change in the target brightness value in a case where the display content is changed without continuity (i.e., such that there is no continuity in display content before and after the change). As a result, an abrupt change in brightness of the display device viewed by a user can be suppressed when, e.g., a large change takes place in the illuminance of outside light irradiated onto the display device, whereby a viewing difficulty can be relieved. It is also possible to ensure that the display brightness can follow up a change in the outside light illuminance without giving the user an unnatural feeling.

Further features of the present invention will become apparent from the following description of exemplary embodiments with reference to the attached drawings.

### BRIEF DESCRIPTION OF THE DRAWINGS

FIG. 1 is a block diagram showing the electric circuit construction of a digital camera having a display control device according to a first embodiment of this invention;

FIG. 2 is an external rear view of a camera main unit;

FIG. 3 is a view showing operation mode transitions in the camera;

FIGS. 4A to 4E are views showing display contents of a display device;

FIG. 5 is a timing chart showing a change in outside light illuminance, illuminance detection timings, a change in target brightness, and a change in set brightness;

FIG. 6 is a flowchart showing the procedures of a brightness setting process in a timer interruption routine;

FIG. 7 is a timing chart showing a change in outside light illuminance, illuminance detection timings, a change in target brightness, a change in set brightness, and a state transition by a switch operation;

FIG. 8 is a flowchart showing the procedure of a brightness setting process initiated by a switch interruption;

FIG. 9 is a timing chart showing a change in outside light illuminance, illuminance detection timings, a change in target brightness, a change in set brightness, and a state transition by a switch operation in a second embodiment of this invention; and

FIG. 10 is a flowchart showing the procedures of a brightness setting process initiated by a switch interruption.

### DETAILED DESCRIPTION OF THE PREFERRED EMBODIMENTS

The present invention will now be described in detail below with reference to the drawings showing preferred embodiments thereof.

### First Embodiment

A display control device according to a first embodiment of this invention is applied to a digital single-lens reflex camera (SLR), but is also applicable to other digital cameras such as a compact camera and a video camera.

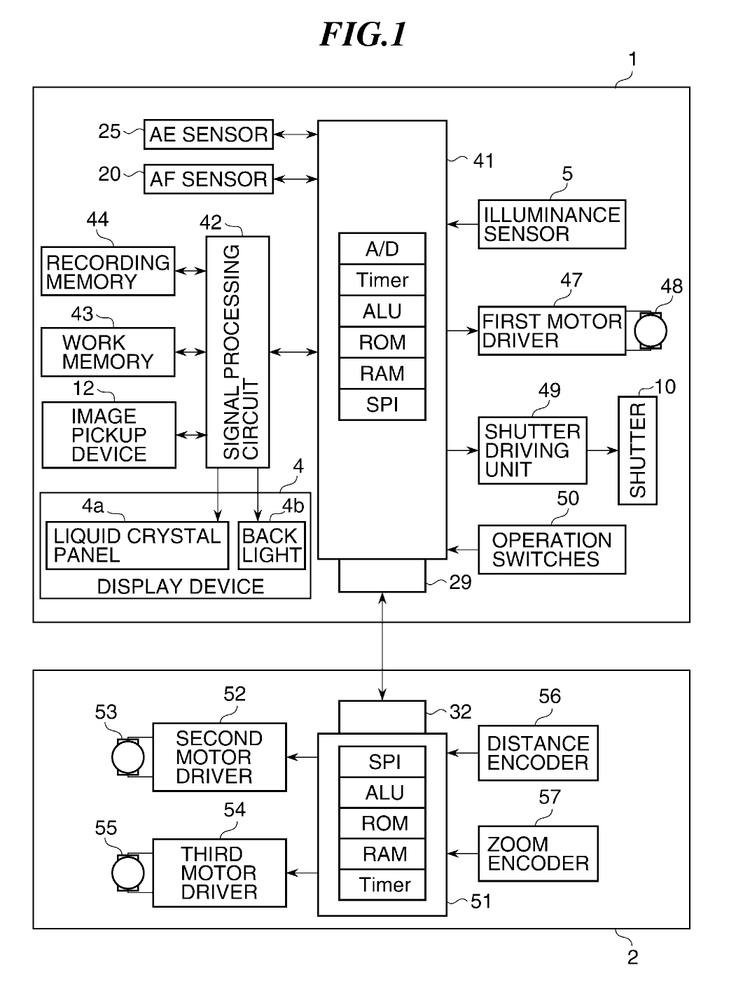

FIG. 1 shows in block diagram the electric circuit construction of the digital camera including the display control device of this embodiment. The digital camera is comprised of a camera main unit 1 and an interchangeable lens 2.

The camera main unit 1 includes a one-chip microcomputer (control unit) 41 that incorporates, e.g., an ALU, a ROM, a RAM, an A/D converter, a timer, and a serial communication port (SPI) and performs overall control of, e.g., a camera mechanism. The details of control performed by the control unit 41 will be described later.

A display device 4 mounted to the camera main unit 1 is implemented by, e.g., a liquid crystal monitor having a liquid crystal panel 4a and a back light 4b. An illuminance sensor 5 includes a photoelectric conversion device (e.g., SPC (silicone photo cell)) for outputting to the A/D converter of the control unit 41 a signal that varies according to illuminance of outside light irradiated onto a rear surface of the camera.

A focus-detecting sensor (AF sensor) 20, which is implemented by an area storage type photoelectric conversion device (e.g., CMOS or CCD), includes paired light receiving sensor sections respectively corresponding to two apertures of a diaphragm of a taking lens, and is able to perform known phase difference AF detection. This sensor 20 is implemented by an integrated circuit having a signal accumulation section, a signal processing peripheral circuit, etc. as well as the light receiving sensor sections, which are all formed on the same chip.

A light metering sensor (AE sensor) 25 is for obtaining information on object brightness and implemented by a photoelectric conversion device (e.g., silicon photodiode). This sensor 25 includes, e.g., a light receiving sensor section divided into segments, and is able to perform backlight detection according to a predetermined algorithm. As is known, the light metering sensor 25 is implemented by an integrated circuit having a signal amplifier, a signal processing peripheral circuit, etc. as well as the light receiving sensor section, which are all formed on the same chip.

An image pickup device 12 is implemented by a CCD or a CMOS area sensor. A signal processing circuit 42 controls the image pickup device 12 in accordance with an instruction given by the control unit 41, inputs and A/D converts an image pickup signal output from the image pickup device 12, and performs signal processing on the image pickup signal to obtain an image signal. The signal processing circuit 42 records the image signal, while performing required image processing (e.g., compression) on the image signal.

A work memory 43 is implemented by, e.g., a DRAM, and is for use by the signal processing circuit 42 as a work memory to perform signal processing and as a VRAM to display an image on the display device 4. A recording memory 44 implemented by, e.g., a nonvolatile memory such as a flash ROM is used for recording picked-up images as a file.

A mechanical shutter 10 is disposed near a focal plane. A shutter driving unit 49 is connected to an output terminal of the control unit 41, and drives the mechanical shutter 10. A first motor driver 47 connected to an output terminal of the control unit 41 is controlled by the control unit 41 to drive a first motor 48 to move a quick return mirror (not shown) upward and downward and charge the mechanical shutter 10.

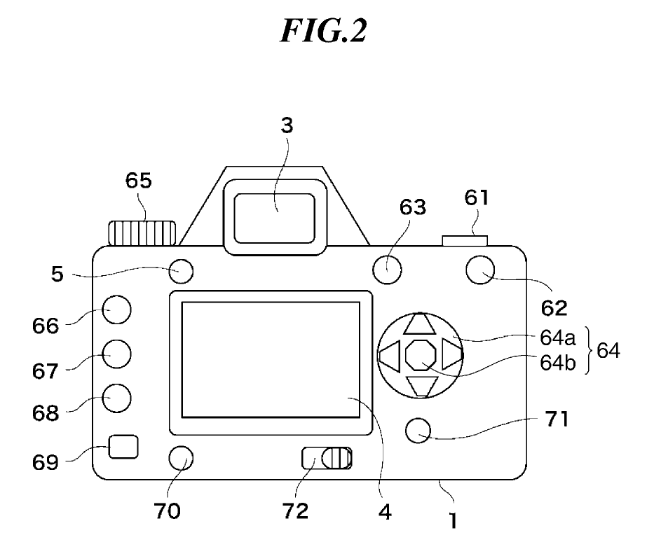

Operation switches 50 are connected to input terminals of the control unit 41. The details of these switches 50 will be described later with reference to FIG. 2.

A contact part 29 is a signal contact part adapted to be in contact with the interchangeable lens 2 and is connected to the serial communication port (SPI) of the control unit 41.

The interchangeable lens 2 includes a lens control unit 51 which is implemented by, e.g., a one-chip microcomputer that incorporates an ALU, a ROM, a RAM, a timer, a serial communication port, etc.

A second motor driver 52 is connected to an output terminal of the lens control unit 51 and controlled by the lens control unit 51 to drive a second motor 53 for focus control. A third motor driver 54 is connected to an output terminal of the lens control unit 51 and controlled by the lens control unit 51 to drive a third motor 55 for diaphragm control.

A distance encoder 56 is for obtaining an amount of projection of a focus adjustment lens, i.e., information on distance to the subject, and is connected to an input terminal of the lens control unit 51. A zoom encoder 57 is for obtaining focal distance information at photographing in a case that the interchangeable lens 2 is a zoom lens, and is connected to an input terminal of the lens control unit 51.

A contact part 32 is a signal contact part adapted to be in contact with the camera main unit 1, and is connected to the serial communication port of the lens control unit 51. When the interchangeable lens 2 is mounted to the camera main unit 1, the contact parts 29, 32 are connected to each other, whereby the lens control unit 51 is able to perform data communication with the control unit 41 of the camera main unit 1.

With this data communication, various information are output from the lens control unit 51 to the control unit 41 of the camera main unit 1. Specifically, lens-specific optical information required for the control unit 41 to perform focus detection and exposure calculation are output, and information on distance to the subject or focal distance information obtained by the distance encoder 56 or the zoom encoder 57 is also output.

With the above data communication, various information are output from the control unit 41 of the camera main unit 1 to the lens control unit 51. Specifically, focus control information and diaphragm information which are obtained by focus detection and exposure calculation by the control unit 41 are output. The lens control unit 51 controls the second motor driver 52 in accordance with the focus control information, and controls the third motor driver 54 in accordance with the diaphragm information.

Next, a description will be given mainly on operation switches. FIG. 2 shows a rear external appearance of the camera main unit 1. On a rear surface of the camera main unit 1, an optical finder eyepiece 3, the display device 4, the illuminance sensor 5, and switches 61 to 72 are disposed. Reference numeral 61 denotes a release switch for still image photographing, 62 denotes a moving image photographing switch for moving image photographing, and 63 denotes a DISP switch for starting a live view display and changing a display mode.

Reference numeral 64 denotes a selection switch 64 having a cross key 64a capable of detecting upward, downward, leftward, and rightward manipulations thereon and a center push switch 64b capable of detecting a pushing manipulation thereon, and 65 denotes a photographing mode dial which is rotatable for selection of various photographing modes such as a program auto mode, a shutter priority mode, a diaphragm priority mode, and a manual mode.

Reference numeral 66 denotes a menu switch for use when displaying a menu for setting camera functions, etc., 67 denotes a zoom-in switch for use when providing partial zoom-in display of a display image, and 68 denotes a zoom-out switch for use when reversing the partial zoom-in display to a zoom-out direction.

Reference numeral 69 denotes a reproduction switch for use when reproducing a recorded image by the display device 4, 70 denotes an erase switch for use when erasing a recorded image, 71 denotes a function switch for use when changing the settings of white balance mode, photographing sensitivity, distance measuring point, etc., and 72 denotes a power switch for use when turning on and off the power of the camera main unit 1.

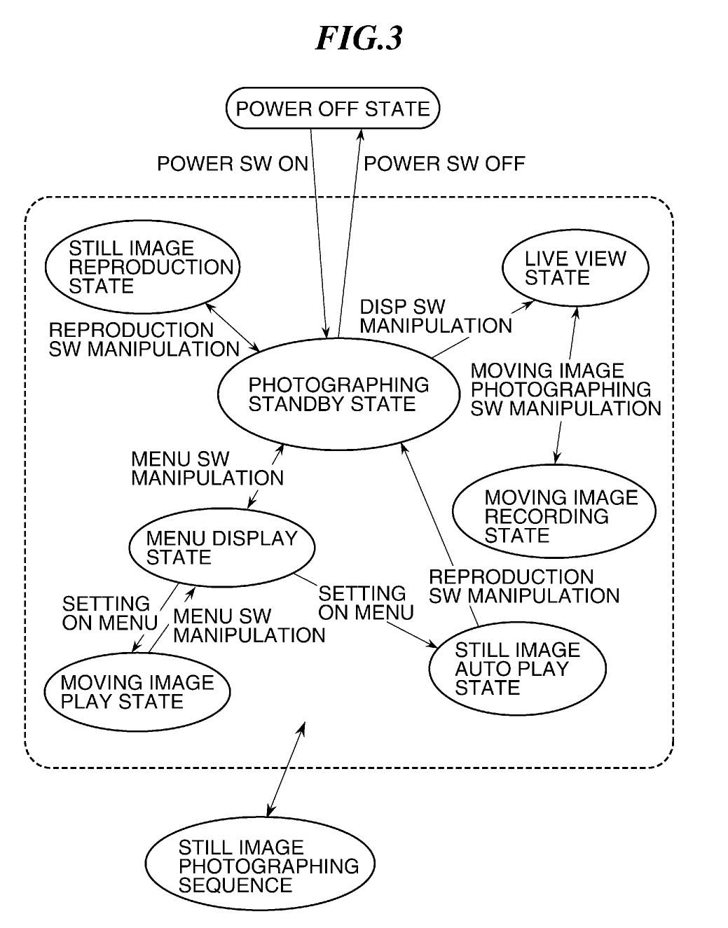

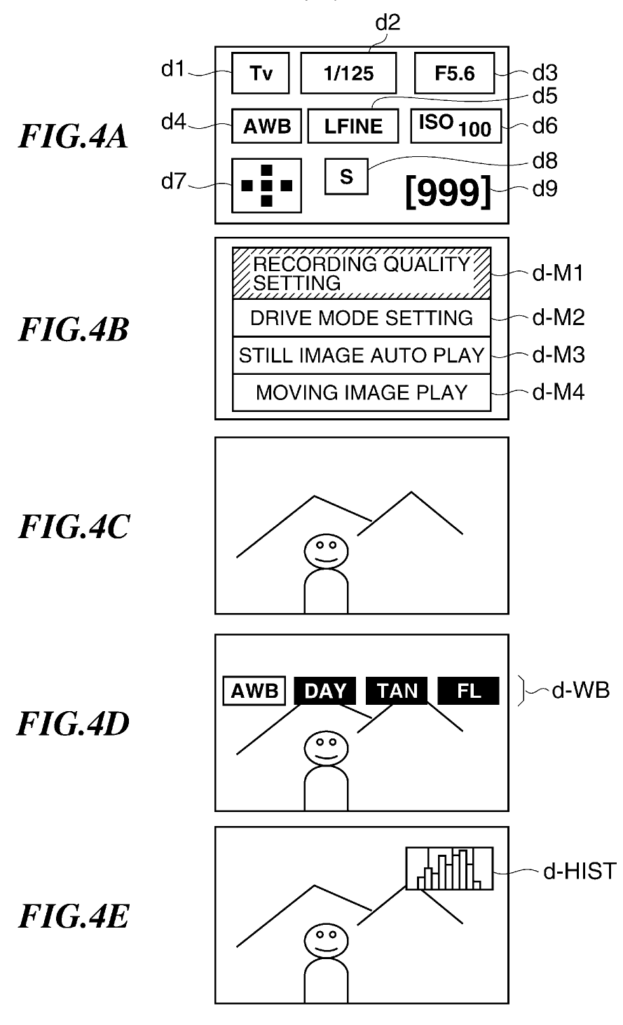

In the following, operations of the digital camera having the above construction will be described. FIG. 3 shows operation mode state transitions in the camera main unit 1, and FIGS. 4A to 4E show display contents of the display device 4. When the power of the camera main unit 1 is turned on by the power switch 72, a shift is made from a power off state to a photographing standby state where photographing information as exemplarily shown in FIG. 4A are displayed in display fields d1 to d9 on the panel 4a of the display device 4.

In the display field d1, a symbol representing a photographing mode currently set by the photographing mode dial 65 is displayed. Specifically, “Tv” is displayed when the shutter priority mode is set by the mode dial 65, “P” is displayed when the program auto mode is set, “Av” is displayed when the diaphragm priority mode is set, and “M” is displayed when the manual mode is set. In this manner, the display content of the display field d1 changes according to the photographing mode.

In the display field d2, a shutter speed manually set or calculated by the camera is displayed in units of seconds. In the display field d3, a diaphragm value (F number) manually set or calculated by the camera is displayed.

In the display field d4, there is displayed a white balance mode currently set by the function switch 71. For example, “AWB” is displayed when an auto white balance mode is set, “DAY” is displayed when a dayglow (sunny) mode is set, “TAN” is displayed when a tungsten light mode is set, and “FL” is displayed when a fluorescent light mode is set.

In the display field d5, the settings of recording size and compression rate are displayed. Recording sizes L, M, S, etc., which are larger in this order, can selectively be set by the menu switch 66. As the compression rate, “FINE” for low compression rate at which high image quality is expected can be selected, or “NORMAL” for general use can be selected.

In the display field d6, a photographing sensitivity value (e.g., 100, 200, 400, 800, 1600) currently set by the function switch 71 is displayed.

In the display field d7, distance measuring points at center, top, bottom, right, and left which are currently set by the function switch 71 are displayed in icon. In the display field d8, a drive mode currently set by the menu switch 66 is displayed. For example, “S” is displayed when a single shooting mode is selected, “C” is displayed when a continuous shooting mode is selected, and “SELF” is selected when a self timer mode is set.

In the display field d9, a recordable number of images (999 in FIG. 4A) is displayed. Specifically, based on a free space of the recording memory 44 and an assumed file size based on currently set recording size, compression rate, etc., the number of photographable images is calculated and displayed.

When the menu switch 66 is set to ON in the photographing standby state, a shift is made to a menu display state as shown in FIG. 3. An example display content of the display device 4 in the menu display state is shown in FIG. 4B.

In the menu display state, a menu including four items d-M1, d-M2, d-M3, and d-M4 is displayed. By manipulating the up and/or down key of the cross key 64a, a desired one of the items d-M1 to d-M4 can be selected. The selected item is distinguished from the other items by being displayed in different color.

When the center push switch 64b of the selection switch 64 is set to ON in the state shown in FIG. 4B where the item d-M1 is selected, a shift is made to a recording size and compression rate setting screen.

When the center push switch 64b is set to ON in a state of the item d-M2 being selected, a shift is made to a drive mode selection screen. When the push switch 64b is operated in a state of the item d-M3 being selected, the operation mode of the camera main unit 1 shifts to a still image auto play state (see FIG. 3).

When the push switch 64b is set to ON in a state of the item d-M4 being selected, the operation mode shifts to a moving image play state. When the menu switch 66 is operated in the menu display state, the camera main unit 1 completes displaying the menu and shifts to the photographing standby state.

When the reproduction switch 69 is operated to be turned ON in the photographing standby state, the operation mode shifts to a still image reproduction state where the display device 4 displays an image of a photographed still image file recorded in the recording memory 44. An example display is shown in FIG. 4C. By manipulating the left or right key of the cross key 64a in this state, another image can be displayed.

By setting the zoom-in switch 67 to ON in the still image reproduction state, a partial zoom-in display of the displayed image can be provided. By setting the zoom-out switch 68 to ON in the state where the partial zoom-in display is provided, the zoom-in display can be returned to an original whole display.

When the reproduction switch 69 is operated in the still image reproduction state, the camera main unit 1 completes the still image reproduction display and shifts to the photographing standby state. When a shift is made from the menu display state to the still image auto play, the camera main unit 1 changes the image display at intervals of a predetermined time period by using automatic frame advance of a still image file recorded in the recording memory 44.

When the reproduction switch 69 is operated in the still image auto play state, the camera main unit 1 completes the still image auto play and shifts to the photographing standby state. When the DISP switch 63 is set to ON in the photographing standby state, a shift is made to a live view state where a quick mirror is flipped upward and an electronic moving image picked up by the image pickup device 12 is through-displayed on the display device 4.

In the live view state, each time the function switch 71 is set to ON, switching display is performed where a white balance mode change indication, a photographing sensitivity change indication, and a distance measuring point change indication are alternately cyclically superimposed on a live view image.

In FIG. 4D, there is shown an example where the white balance mode change indication (d-WB) is superimposed on a live view image. A currently selected white balance mode (“AWB” in FIG. 4D) is displayed in color different from that of the other non-selected modes. By manipulating the left and/or right key of the cross key 64a in this state, the white balance mode to be selected can be changed. Similarly, the photographing sensitivity change indication and the distance measuring point change indication can be displayed although a description thereof is omitted. When the DISP switch 63 is operated in the live view state, the camera main unit 1 completes the live view display, moves the quick mirror downward, and returns to the photographing standby state.

When the moving image photographing switch 62 is manipulated to be ON in the live view state, the operation mode shifts to the moving image recording state where an electronic moving image picked up by the image pickup device 12 and displayed on the display device 4 is recorded as a file in the recording memory 44.

In the moving image recording state, each time the function switch 71 is set to ON, switching display is performed where a realtime histogram indication for a photographed image and an indication of selected distance measuring point positions are alternately cyclically superimposed on a moving image currently displayed on the display device 4.

In FIG. 4E, an example is shown where the realtime histogram indication for photographed image, d-HIST, is superimposed on a moving image displayed on the display device 4. Similarly, the superimposed indication of selected distance measuring point positions can be provided although a description thereof is omitted. When the moving image photographing switch 62 is manipulated to be ON again in the moving image recording state, the camera main unit 1 completes the moving image recording and shifts to the live view state.

When the item d-M4, i.e., moving image play, is selected in the menu display state by a manipulation of the selection switch 64, the camera main unit 1 reproduces a moving image file recorded in the recording memory 44.

When the menu switch 66 is manipulated in the moving image play state, the camera main unit 1 completes the moving image play and shifts to the menu display state. As described later, when the release switch 61 is manipulated to be ON in the moving image recording state, the camera main unit 1 suspends the moving image recording and performs still image photographing (hereinafter referred to as the interceptive still image photographing). Therefore, a moving image file subjected to the interceptive still image photographing sometimes lacks continuity at a portion corresponding to the execution timing of the interceptive still image photographing. For that portion, black display is provided for a time period of about several seconds during the moving image play.

When the release switch 61 is manipulated to be ON in any of the above-described seven states, the camera main unit 1 shifts to a still image photographing sequence, described below.

In the still image photographing sequence, the control unit 41 extinguishes the display device 4, inputs a signal from the focus-detecting sensor 20 to obtain distance measurement information, and communicates with the lens control unit 51 so as to move the lens to an in-focus position. Then, the control unit 41 inputs a signal from the light metering sensor 25 to obtain light metering information, decides a shutter speed and a diaphragm value (f-stop number) for optimum exposure, and transmits the decided diaphragm value to the lens control unit 51 so that the aperture is closed. The control unit 41 drives the first motor driver 47 to flip the quick return mirror upward, and controls the shutter driving unit 49 to drive the mechanical shutter 10.

In a case where a shift is made from the live view state or the moving image recording state to the still image photographing sequence, the quick return mirror is already flipped upward and the mechanical shutter 10 is already opened, and the distance measurement information or the light metering information is already obtained from the image pickup device 12. Thus, the above-described operations are omitted.

Next, the control unit 41 resets all the pixels of the image pickup device 12 to discharge accumulated charges, and causes predetermined charge accumulation to thereby capture a still image. After completion of the capturing, the control unit 41 controls the shutter driving unit 49 to close the mechanical shutter 10, and drives the first motor driver 47 to move the quick return mirror downward and charge the mechanical shutter 10.

The control unit 41 communicates with the lens control unit 51 and opens the diaphragm. The still image information captured by the image pickup device 12 is read by the signal processing circuit 42 and is A/D converted, and development processing is performed thereon. After completion of the development processing, the control unit 41 displays a photographing preview image on the display device 4 for a predetermined time period. During the preview image being displayed, switching display is performed where a brightness histogram indication for a photographing preview image and an indication of distance measuring point positions at photographing are alternately cyclically superimposed on the photographing preview image on the display device 4 each time the function switch 71 is set to ON. Concurrently with the preview image display, conversion into a still image recording file and a compression process are executed, and the still image recording file is recorded in the recording memory 44.

At completion of the still image photographing sequence, the operation mode of the camera main unit 1 usually returns to the photographing standby state. However, in a case that the still image photographing sequence shifted from the live view state or the moving image recording state is completed, the operation mode returns to the live view state or the moving image recording state.

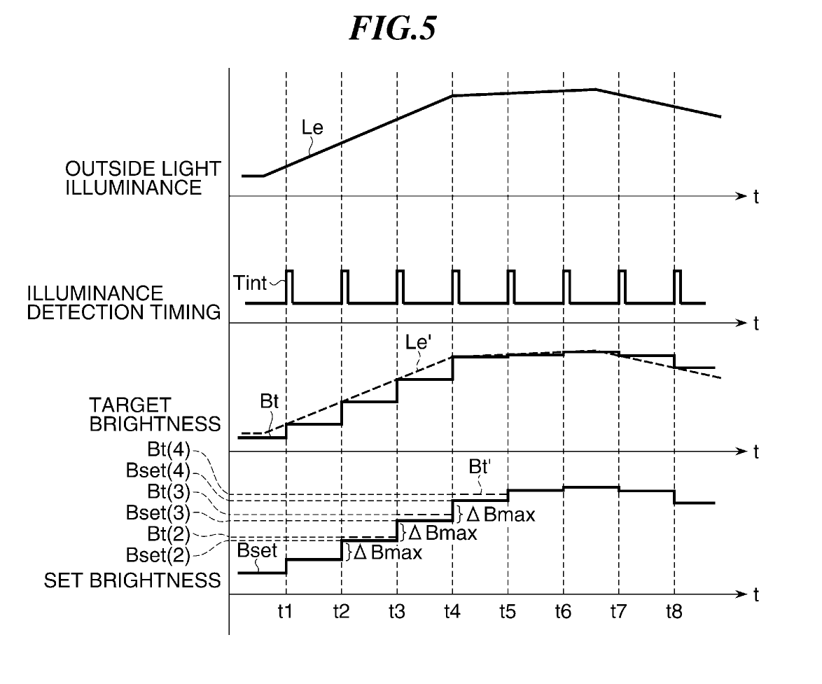

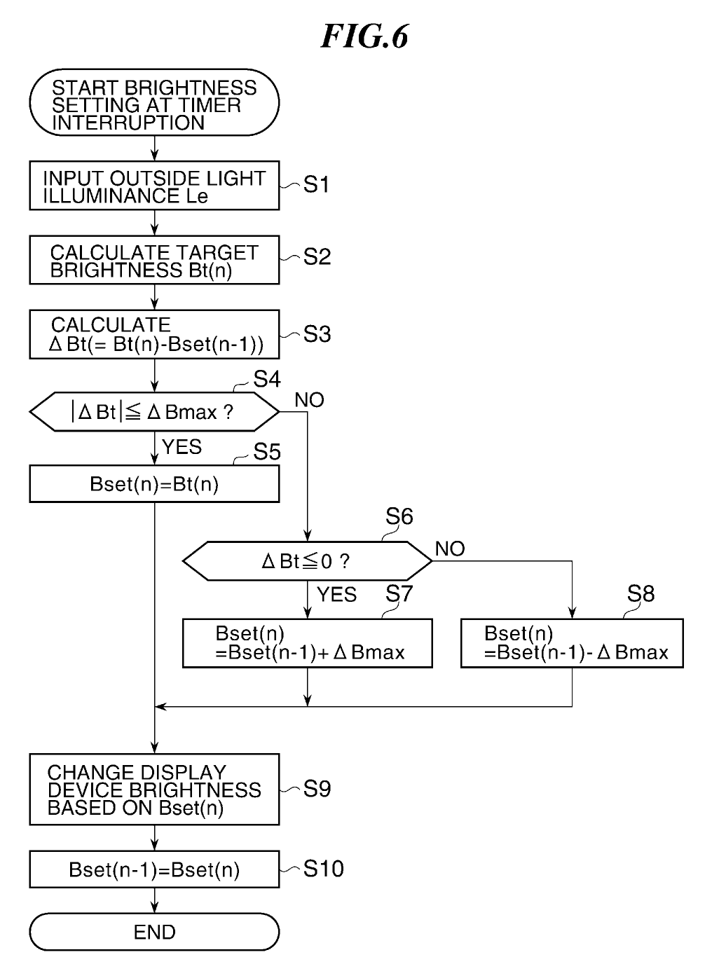

Next, with reference to FIGS. 5 and 6, a description will be given of brightness control for the display device 4 for a case where the photographing standby state is continued and a display content as exemplarily shown in FIG. 4A is not changed but continued to be displayed.

FIG. 5 shows in timing chart a change in outside light illuminance, illuminance detection timings, a change in target brightness, and a change in set brightness. In FIG. 5, elapsed time is shown along the abscissa. With elapse of time, the illuminance of outside light irradiated onto the camera changes as shown by outside light illuminance Le.

In the example in FIG. 5, the outside light illuminance Le increases with a relatively large change amount in a region about from time t1 to time t4, increases with a relatively small change amount in a region about from time t4 to time t6, and then decreases with a medium change amount.

The control unit 41 uses its timer function to perform an interrupt operation at intervals of a predetermined time period, to detect the outside light illuminance Le by the illuminance sensor 5. In FIG. 5, the detection timings are denoted by illuminance detection timing signals Tint. At rise of each timing signal Tint, a timer interruption occurs in the control unit 41, and the control unit 41 detects the outside light illuminance and executes a timer interruption routine for setting the brightness of the display device 4 based on the detection result. Since a main routine processing (i.e., a basic operation of the digital camera executed under the control of the control unit 41) does not directly relate to this invention, a description thereof is omitted.

With reference to FIG. 6, a description will be given of a specific example of the timer interruption routine. FIG. 6 shows in flowchart the procedures of a brightness setting process by the timer interruption routine. When a timer interruption occurs, the control unit 41 starts the brightness setting process.

First, the control unit 41 inputs and A/D converts an output signal of the illuminance sensor 5 to obtain information on outside light illuminance Le at that time point (step S1). Based on a value of outside light illuminance Le, the control unit 41 calculates a target brightness Bt(n) of the display device 4 optimum for the outside light illuminance Le (step S2). In the calculation, the target brightness Bt(n) can be calculated in accordance with an arithmetic expression or can be obtained by referring to a table prepared in advance. The arithmetic expression and the table can be determined based on a relation between outside light illuminance and target brightness value, which is determined in advance from experimental data or known data. The processing in step S2 is an example acquisition unit for acquiring a target brightness value.

Symbols Bt(n) represent a target brightness time series corresponding to illuminance detection timing signals Tint. If the interrupt processing currently executed is initiated at timing t2 in FIG. 5, the target brightness Bt(n), i.e., Bt(2), is calculated based on a value of outside light illuminance Le at timing t2, and the target brightness calculated in the interrupt processing executed in the immediately preceding timing t1 is represented by Bt(n-1), i.e., Bt(1). In this manner, each target brightness Bt(n) is updated in accordance with the outside light illuminance Le each time the timer interruption occurs at rise of timing signal Tint (i.e., at each of timings t1 to t8). Thus, the target brightness Bt(n) changes stepwise as shown by a solid line Bt in FIG. 5. A dotted line Le′ connecting rising edges of the stepwise solid line Bt is shown for ease of understanding the change of outside light illuminance Le.

A symbol Bset(n) indicates a setting value of brightness of the display device 4 to be determined in the current cycle of the interrupt processing, and Bset(n-1) indicates a setting value of brightness determined in the immediately preceding cycle of the interrupt processing and currently set for the display device 4.

In accordance with the following formula (1), the control unit 41 calculates a difference ΔBt between the target brightness Bt(n) calculated in step S2 and the current brightness setting value Bset(n-1) (step S3).

ΔBt=Bt(n)−Bset(n-1) (1)

The control unit 41 determines whether the absolute value of the calculated difference ΔBt is equal to or less than a predetermined upper limit value ΔBmax or larger than the value ΔBmax (step S4). If the absolute value of the difference ΔBt is equal to or less than the upper limit value ΔBmax, the control unit 41 proceeds to step S5.

The upper limit value ΔBmax is an upper limit amount of change in the brightness setting value per interrupt processing cycle. Under circumstances where the outside light illuminance Le abruptly changes, if the brightness setting value Bset(n) is abruptly changed with the changing outside light illuminance, the resultant change in the display brightness of the display device 4 becomes too sensitive, which makes it difficult in some cases for the camera user to view the panel 4a of the display device 4. To obviate this, the upper limit value ΔBmax is provided to moderate the change in brightness setting value.

If the answer to step S4 is affirmative (YES), the control unit 41 sets the value of target brightness Bt(n) calculated in step S2, as it is, as the brightness setting value Bset(n) (step S5).

On the other hand, if it is determined in step S4 that the absolute value of difference ΔBt is larger than the upper limit value ΔBmax, the control unit 41 determines whether the value of difference ΔBt is positive or negative (step S6). If the value of difference ΔBt is positive, the control unit 41 proceeds to step S7.

In a case that the value of difference ΔBt is positive, i.e., if the target brightness Bt(n) in the current cycle is larger by more than the upper limit value ΔBmax than the brightness setting value Bset(n-1) currently set, it is considered that the brightness setting value Bset(n) should be made larger by more than the upper limit value ΔBmax than the brightness setting value Bset(n-1). In that case, however, an excessively large change takes place in the brightness setting value. Thus, the control unit 41 sets the brightness setting value Bset(n) in the current cycle of the interrupt processing to a value obtained by adding the upper limit value ΔBmax to the current brightness setting value Bset(n-1) in accordance with the following formula (2), to thereby prevent an abrupt change in the display brightness (step S7).

Bset(n)=Bset(n-1)+ΔBmax (2)

On the other hand, if it is determined in step S6 that the value of difference ΔBt is negative, the control unit 41 proceeds to step S8. In a case that the value of difference ΔBt is negative, i.e., if the target brightness Bt(n) is smaller by more than the upper limit value ΔBmax than the brightness setting value Bset(n-1), it is considered that the brightness setting value Bset(n) should be made smaller by more than the upper limit value ΔBmax than the brightness setting value Bset(n-1). In that case, however, an excessively large change takes place in the brightness setting value.

Thus, the control unit 41 sets the brightness setting value Bset(n) in the current cycle of the interrupt processing to a value obtained by subtracting the upper limit value ΔBmax from the current brightness setting value Bset(n-1) in accordance with the following formula (3), thereby preventing an abrupt change in the display brightness (step S8).

Bset(n)=Bset(n-1)−ΔBmax (3)

Upon completion of the processing in steps S5, S7, or S8, the control unit 41 proceeds to step S9 and gives the signal processing circuit 42 an instruction to change the brightness of the display device 4 based on the brightness setting value Bset(n) decided in step S5, S7, or S8.

In accordance with the instruction, the signal processing circuit 42 changes the brightness of the back light 4b of the display device 4. In a case where the brightness of the back light 4b reaches a changeable upper or lower limit value, the brightness cannot further be changed. On the other hand, it is possible to artificially make an image look like bright or dark by changing a permeability vs. input value characteristic of the liquid crystal panel 4a. Such technique can be combinatorially used in an outside light illuminance region where the brightness of the back light 4b cannot further be changed.

The control unit 41 stores the brightness setting value Bset(n) used in step S9 as the brightness setting value Bset(n-1) for use in the next interrupt processing (step S10), and completes the interruption routine.

When the interruption routine is executed at each of timings t1 to t8 shown in FIG. 5, the set brightness Bset(n) changes as shown by the solid line Bset. In the interruption routine executed in timing t1, the value of target brightness Bt(n) per se is set as the brightness setting value Bset(n).

On the other hand, in the interruption routines executed in timings t2 to t4, a change in outside light illuminance Le is large, and the absolute value of difference ΔBt becomes larger than the upper limit value ΔBmax. Thus, the brightness setting value Bset(n) is not made equal to the value of target brightness Bt(n) per se (see, dotted line Bt′), but made equal to a value obtained in step S7 by adding ΔBmax to Bset(n-1), whereby the brightness setting value changes moderately.

In the interruption routines executed in timing t5 and subsequent timings, a change in outside light illuminance Le becomes small, and the value of target brightness Bt(n) per se is set as the brightness setting value Bset(n). The brightness setting control for the display device 4 is carried out not only in a case that the photographing standby state is continued and the display content as exemplarily shown in FIG. 4A is continued to be displayed without any change, but also in each of the states shown in FIG. 3.

Specifically, the brightness setting control in FIG. 6 is carried out in the following cases: (i) where the display content as exemplarily shown in FIG. 4B is continued to be displayed without any change in the menu display state; (ii) where the display content as exemplarily shown in FIG. 4C is continued to be displayed without any change in the still image reproduction state; and (iii) where the reproduction of the same image is continued for a predetermined time period in the still image auto play state.

In the live view state and the moving image recording state, a camera-through moving image is displayed by the display device 4 and hence the same image is not continued to be displayed. However, the brightness setting control in FIG. 6 is executed in a case (iv) where the indication (i.e., the white balance mode change indication, the photographing sensitivity change indication, or the distance measuring point change indication) superimposed on a live view image in the live view state is not changed by a manipulation on the function switch 71 and in a case (v) where the indication (i.e., the realtime histogram indication for photographed image, or the indication of selected distance measuring point positions) superimposed on a moving image in the moving image recording state is not changed by a manipulation on the function switch 71.

In the moving image play state, a recorded moving image is displayed by the display device 4 and hence the same image is not continued to be displayed. In that case (vi), however, the brightness setting control basically similar to that shown in FIG. 6 is carried out.

In the still image photographing sequence, the brightness setting control in FIG. 6 is performed in a case (vii) where the indication (i.e., the brightness histogram indication for a photographing preview image or the indication of selected distance measuring point positions at photographing) superimposed on a photographing preview image displayed on the display device 4 is not changed by a manipulation on the function switch 71.

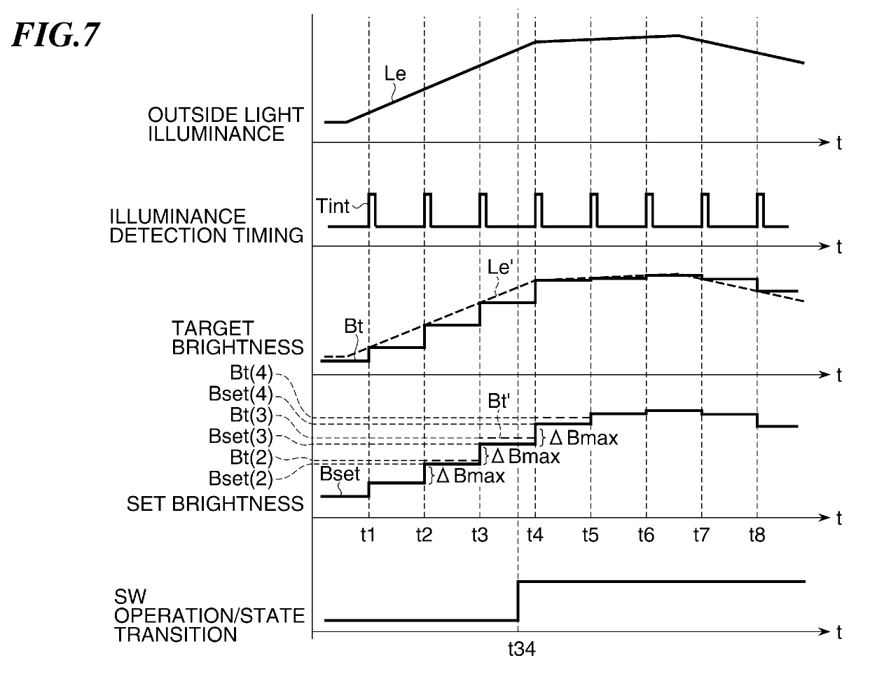

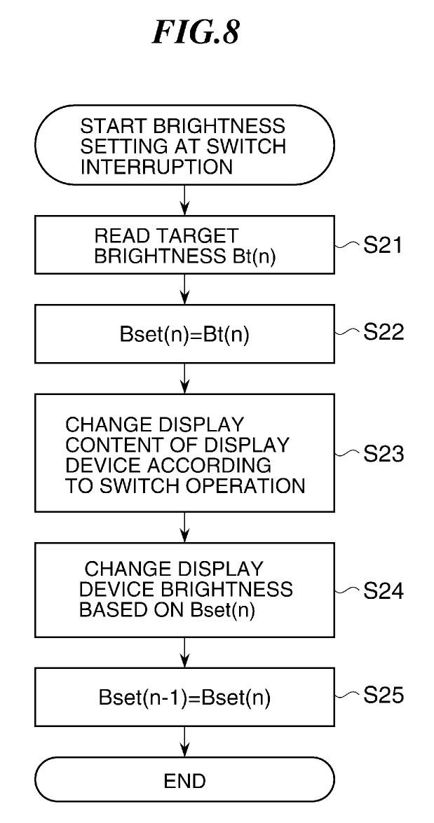

Next, with reference to FIGS. 7 and 8, a description will be given of brightness control for the display device 4 in a case where a switch operation is performed in the photographing standby state and hence the display content is changed. An example display content of the display device 4 in the photographing standby state is shown in FIG. 4A, and switch operations by which the display content is changed are previously described with reference to FIG. 4A.

FIG. 7 shows in timing chart a change in outside light illuminance, illuminance detection timings, a change in target brightness, a change in set brightness, and a state transition by a switch operation. In FIG. 7, elapsed time is shown along abscissa. FIG. 7 shows, as with FIG. 5, a change in outside light illuminance Le with elapse of time, illuminance detection timing signals Tint in accordance with which the outside light illuminance is detected and the brightness of the display device 4 is set, and target brightness Bt calculated in the interrupt processing.

It is assumed that a switch operation by which the display content is changed is performed in the photographing standby state in timing t34 between timings t3 and t4. Since no switch operation is performed before timing t34 and there is no change in the display content of the display device 4, changes in outside light illuminance, etc. observed before timing t34 are the same as those shown in FIG. 5.

When the switch operation is performed in timing t34, the control unit 41 detects the switch operation as interruption and starts the interrupt processing in FIG. 8. FIG. 8 shows in flowchart the procedures of a brightness setting process initiated by a switch interruption.

The control unit 41 reads the target brightness Bt(n) calculated at the immediately preceding interruption by the timing signal Tin, which is closest in timing to and generated before occurrence of the switch interruption (step S21). In this example, the target brightness Bt(3) calculated at the interruption in timing t3 is read. The control unit 41 sets the read target brightness Bt(n) as a brightness setting value Bset(n) for the display device 4 (step S22).

The control unit 41 gives the signal processing circuit 42 an instruction to change the display content of the display device 4 according to the switch operation (step S23). In a case, for example, that the photographing mode dial 65 is rotated, the content in the display field d1 in FIG. 4A is changed so as to meet the rotary position of the photographing mode dial 65. In other words, the display content of the display device 4 is changed by the switch operation without continuity (i.e., such that there is no continuity in display content before and after the change).

Based on the brightness setting value Bset(n) set in step S22, the control unit 41 gives the signal processing circuit 42 an instruction to change the brightness of the display device 4 (step S24). In accordance with the instruction, the signal processing circuit 42 changes the brightness of the back light 4b of the display device 4.

In a case where the brightness of the back light 4b reaches a changeable upper or lower limit value, a technique to artificially make an image look like bright or dark by changing a permeability vs. input value characteristic of the liquid crystal panel 4a can be combinatorially used in an outside light illuminance region where the brightness of the back light 4b cannot further be changed, as with the processing in step S9.

The control unit 41 stores the brightness setting value Bset(n) set in step S22 as a brightness setting value Bset(n-1) for use in the next interrupt processing (step S25), and completes the brightness setting process.

As described above, in the interrupt processing in FIG. 8, an upper limit value is not provided for an amount of change in setting the brightness of the display device 4, and therefore the brightness of the display device 4 is set so as to be always consistent with the target brightness Bt(n) calculated at the interruption caused by the immediately preceding timing signal Tint.

Since the timing of change of the display content of the display device 4 responsive to the switch operation and the timing of brightness change are matched to each other, it is possible to set the optimum display brightness that does not give the camera user an unnatural feeling and a difficulty in viewing the display.

The fact that such processing is certainly executed is indicated by FIG. 7 in that, in timing t34, the solid line Best is consistent with the target brightness Bt(3).

The brightness setting process shown in FIG. 8 is performed not only in the photographing standby state but also in the other states shown in FIG. 3. In other words, the brightness setting process is carried out in a case where there is continuity in display content of the display device 4 (i.e., the display content is not changed and the same display content is maintained, or the display content is changed such that the same display content is not maintained, but the display content is continuous before and after the change) and in a case where the display content is changed without continuity.

Specifically, the brightness change process shown in FIG. 8 is carried out in the following cases: (I) where the item to be selected from the items d-M1, d-M2, d-M3, and d-M4 in FIG. 4B is changed in the menu display state by a manipulation of the selection switch 64; (II) where a shift is made to a screen for setting the details of the selected item; (III) where an image to be displayed is changed in the still image reproduction state by a manipulation of the cross key 64a; and (IV) where the size of the displayed image is changed by a manipulation of the zoom-in switch 67 or the zoom-out switch 68.

The brightness setting process of FIG. 8 (i.e., interrupt processing similar to that initiated by a switch interruption) is also performed at frame advance timings in a case (V) where automatic frame advance of a still image file is made at predetermined time intervals in the still image auto play state although a switch interruption does not occur in the timing of image display switching by the frame advance.

The brightness setting process of FIG. 8 is also carried out in the following cases: (VI) where the indication superimposed on a live view image is changed in the live view state by a manipulation of the function switch 71 between the white balance mode change indication, the photographing sensitivity change indication, and the distance measuring point change indication; and (VII) where the indication superimposed on a moving image being displayed on the display device 4 is changed in the moving image recording state by a manipulation of the function switch 71 between the realtime histogram indication and the indication of selected distance measuring point positions.

The brightness setting process of FIG. 8 (i.e., interrupt processing similar to that initiated by a switch interruption) is also carried out at a timing of black display in a case (VIII) where the black display is provided for a predetermined time period during the reproduction of a moving image file in the moving image play state at a timing corresponding to a timing where interceptive still image photographing was executed during recording of the moving image although a switch interruption does not occur at the timing of the black display.

The brightness setting process of FIG. 8 is carried out also in the following cases: (IX) where the indication superimposed on a photographing preview image displayed by the display device 4 is changed during the still image photographing sequence by a manipulation of the function switch 71 between the brightness histogram indication and the indication of selected distance measuring point positions at photographing; and (X) where a shift is made as shown in FIG. 3 between the states by a switch operation, and the display content of the display device 4 is changed without continuity.

As described above, with the display control device according to the first embodiment, the brightness is changed at the timing where the display content of the display device 4 is changed mainly in response to a camera user's manipulation, while removing the limitation on a change in display brightness of the display device that corresponds to a change in the outside light illuminance.

As a result, even when a large change takes place in illuminance of outside light irradiated onto the camera, it is possible to suppress an abrupt change in brightness of the display device 4 of the camera viewed by the camera user to thereby relieve a viewing difficulty. Also, it is ensured that the display brightness can follow up a change in outside light illuminance, without giving the user an unnatural feeling. By calculating the target brightness value at intervals of a predetermined time period, it is further ensured that the display brightness can follow up a change in outside light illuminance.

The display brightness is changed at once to a brightness optimum for the outside light illuminance at a timing where the display content of the display device is changed without continuity by a manipulation on the camera. As a result, it is reliably ensured that the display brightness can follow up a change in outside light illuminance, without giving the user an unnatural feeling.

Since the timing of change in the display content of the display device in each camera operation mode and the timing of brightness change are matched to each other, it is possible to set the optimum display brightness that does not give the camera user an unnatural feeling and a difficulty in viewing the display.

As described above, the brightness of the display device of the camera can properly be controlled.

### Second Embodiment

In the first embodiment, the case has been described where the brightness of the display device 4 is set such that the display device brightness is consistent with the target brightness Bt(n) calculated at the interruption initiated by the timing signal Tint immediately preceding the timing where the display content of the display device 4 is changed by a switch operation.

In a second embodiment, there will be described a brightness setting technique having an excellent ability of following up a change in outside light illuminance Le. A digital camera of the second embodiment is the same in electrical circuit construction and external appearance as those of the first embodiment (see FIGS. 1 and 2), and hence a description thereof is omitted. The second embodiment is also the same as the first embodiment in respect of state transitions of the camera operation mode (see FIG. 3), the timing chart of FIG. 5, and the flowchart of FIG. 6, and a description thereof is omitted.

In the second embodiment, a brightness setting process different from that of the first embodiment shown in FIG. 8 is performed, as will be described below.

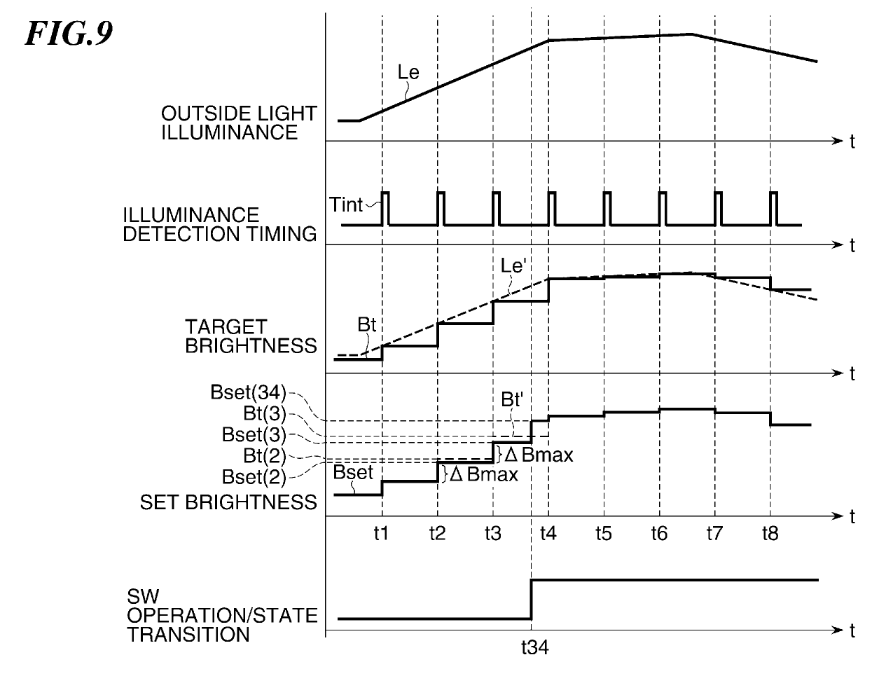

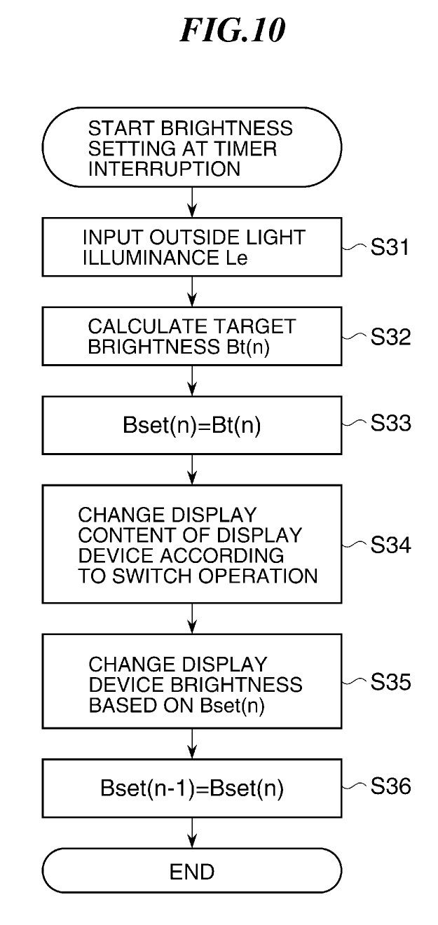

FIG. 9 shows in timing chart a change in outside light illuminance, illuminance detection timings, a change in target brightness, a change in set brightness, and a state transition caused by a switch operation in the second embodiment. FIG. 10 shows in flowchart the procedures of the brightness setting process, which is initiated by a switch interruption.

In FIG. 9, as with FIG. 7, it is assumed that a switch operation to change the display content in the photographing standby state is performed in timing t34 between timings t3 and t4. At this switch operation timing, the display content of the display device 4 is changed without continuity.

When the switch operation is performed in timing t34, the control unit 41 detects the switch operation as interruption, and starts interrupt processing of FIG. 10. The control unit 41 inputs and A/D converts an output signal of the illuminance sensor 5 to obtain information on outside light illuminance Le at that time point (step S31).

As with step S2 in the first embodiment, based on the outside light illuminance Le obtained in step S31, the control unit 41 calculates a target brightness Bt(n) of the display device 4 optimum for the outside light illuminance Le (step S32).

The control unit 41 sets a value of the target brightness Bt(n) calculated in step S32, as it is, as a brightness setting value Bset(n) of the display device 4 (step S33), and gives the signal processing circuit 42 an instruction to change the display content of the display device 4 according to the switch operation (step S34).

Based on the brightness setting value Bset(n) set in step S33, the control unit 41 gives the signal processing circuit 42 an instruction to change the brightness of the display device 4 (step S35). In accordance with the instruction, the signal processing circuit 42 changes the brightness of the back light 4b of the display device 4.

In a case where the brightness of the back light 4b reaches a changeable upper or lower limit value, a technique to artificially make an image look like bright or dark by changing a permeability vs. input value characteristic of the liquid crystal panel 4a can be combinatorially used in an outside light illuminance region where the brightness of the back light 4b cannot further be changed, as with the first embodiment.

The control unit 41 stores the brightness setting value Bset(n) set instep S33 as a brightness setting value Bset(n-1) for use in the next interrupt processing (step S36), and completes the brightness setting process.

As described above, with the display control device of the second embodiment, a value of outside light illuminance Le is detected at the time of occurrence of interruption and the brightness of the display device 4 optimum for the detected outside light illuminance is set without providing an upper limit value of an amount of change in the interrupt processing of FIG. 10. The fact that such processing is certainly executed is indicated by FIG. 9 in that a new brightness setting value Best(34) is set in timing t34, whereby the brightness setting for the display device 4 can be made such that the display device brightness can satisfactorily follow up a change in outside light illuminance Le.

Since the timing of change of the display content of the display device 4 by the switch operation and the timing of brightness change are matched to each other, the optimum display brightness can be set, without giving the camera user an unnatural feeling and a difficulty in viewing the display, as with the first embodiment.

The brightness setting process in FIG. 10 is executed in timings all of which are the same as the execution timings of the brightness setting process in FIG. 8. In other words, the brightness setting process is carried out in cases where a switch operation is performed that causes the operation mode of the camera main unit 1 to be transited between the states shown in FIG. 3, where a switch operation is performed that causes a state transition with a change in display content, and where a switch operation is not performed but a large change automatically takes place in display content.

It should be noted that this invention is not limited to the constructions of the above embodiments, but applicable to any construction having the functions recited in the appended claims or capable of achieving the functions provided by the constructions of the embodiments.

For example, in the first embodiment, an upper limit value is provided for an amount of change in target brightness value in the setting of a brightness setting value in order to restrict the amount of change in target brightness value. However, instead of providing the upper limit value, various restriction methods can be used such as multiplying the amount of change by a coefficient less than 1.

In the embodiments, cases have been described where this invention is applied to a display device of a camera such as a digital camera or a video camera, but this is not limitative. This invention is applicable to a display device of various electronic equipment such as portable information terminals, portable cell phones, and portable electronic equipment (e.g., a notebook PC).

As the display device, a back light type LCD panel (liquid crystal display), an organic EL display, a surface-conduction electron-emitter display (SED), a plasma display, or the like can be used.

In the case of a display device (e.g., an organic EL) not having a back light but having a self-luminous device, the back light brightness is not controlled, but the light emitting brightness of the display device is directly controlled.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-001855, filed Jan. 7, 2009, which is hereby incorporated by reference herein in its entirety.

What is claimed is:

1. A display control device for controlling a display device that displays an image, comprising:
a detection unit configured to detect illuminance of outside light irradiated onto the display device;
an acquisition unit configured to acquire a target brightness value corresponding to the detected illuminance of outside light; and
a control unit configured to control brightness of the display device to a brightness setting value set based on the acquired target brightness value,
wherein said control unit sets the brightness setting value while restricting an amount of change in the target brightness value in a case where there is continuity in display content of the display device, and sets the target brightness value as the brightness setting value while unrestricting the amount of change in the target brightness value in a case where the display content of the display device is changed without continuity.

2. The display control device according to claim 1, wherein said acquisition unit calculates the target brightness value at intervals of a predetermined time period based on the illuminance of outside light detected by said detection unit, and
said control unit sets the brightness setting value while providing an upper limit in the amount of change in the calculated target brightness value in a case where there is continuity in display content of the display device.

3. The display control device according to claim 1, wherein based on the illuminance of outside light detected by said detection unit, said acquisition unit acquires the target brightness value at a timing where the display content of the display device is changed without continuity, and
said control unit sets the acquired target brightness value as the bright setting value.

4. The display control device according to claim 1, wherein the display device is mounted to a camera, and displays an image according to an operation mode of the camera.

5. The display control device according to claim 4, wherein the case where the display content of the display device is changed without continuity is a case where a switch operation is performed in a photographing standby state and the display content is changed.

6. The display control device according to claim 4, wherein the case where the display content of the display device is changed without continuity is a case where an operation to change an item to be selected from items is performed in a menu display state or a case where a shift is made to a screen for performing setting for the selected item.

7. The display control device according to claim 4, wherein the case where the display content of the display device is changed without continuity is a case where a displayed image is changed by a switch operation in a still image reproduction state.

8. The display control device according to claim 4, wherein the case where the display content of the display device is change without continuity is a case where a still image is automatically changed by frame advance in a still image auto play state.

9. The display control device according to claim 4, wherein the case where the display content of the display device is changed without continuity is a case where an indication superposed on a live view image in a live view state is changed by a switch operation between a white balance mode change indication, a photographing sensitivity change indication, and a distance measuring point change indication.

10. The display control device according to claim 4, wherein the case where the display content of the display device is changed without continuity is a case where an indication superimposed on a moving image in a moving image recording state is changed by a switch operation between a realtime histogram indication and an indication of selected distance measuring point positions.

11. The display control device according to claim 4, wherein the case where the display content of the display device is changed without continuity is a case where black display is provided during reproduction of a moving image in a moving image play state for a predetermined time period at a timing that corresponds to a timing where interceptive still image photographing was made during recording of the moving image.

12. The display control device according to claim 4, wherein the case where the display content of the display device is changed without continuity is a case where an indication superimposed on a photographing preview image is changed by a switch operation in a state where the photographing preview image is displayed.

13. The display control device according to claim 4, wherein the case where the display content of the display device is changed without continuity is a case where a shift is made between various states by a switch operation.

14. A display control device for controlling a display device that displays an image, comprising:
a detection unit configured to detect illuminance of outside light irradiated onto the display device;
an acquisition unit configured to acquire a target brightness value corresponding to the detected illuminance of outside light; and
a control unit configured to control brightness of the display device to a brightness setting value set based on the acquired target brightness value,
wherein based on the illuminance of outside light detected by said detection unit, said acquisition unit acquires the target brightness value at a timing where the display content of the display device is changed without continuity.

15. A display control method of a display control device for controlling a display device that displays an image, comprising:
a detection step of detecting, by the display control device, illuminance of outside light irradiated onto the display device;
an acquisition step of acquiring, by the display control device, a target brightness value corresponding to the detected illuminance of outside light; and
a control step of controlling, by the display control device, brightness of the display device to a brightness setting value set based on the acquired target brightness value,
wherein in said control step, the brightness setting value is set while restricting an amount of change in the target brightness value in a case where there is continuity in display content of the display device, and the target brightness value is set as the brightness setting value while unrestricting the amount of change in the target brightness value in a case where the display content of the display device is changed without continuity.

16. A display control method of a display control device for controlling a display device that displays an image, comprising:
a detection step of detecting, by the display control device, illuminance of outside light irradiated onto the display device;
an acquisition step of acquiring, by the display control device, a target brightness value corresponding to the detected illuminance of outside light; and
a control step of controlling, by the display control device, brightness of the display device to a brightness setting value set based on the acquired target brightness value,
wherein based on the illuminance of outside light detected in said detection step, the target brightness value is acquired in said acquisition step at a timing where the display content of the display device is changed without continuity.
